(19) United States
(12) Patent Application Publication
(10) Pub. No.: US 2008/0203696 A1
(43) Pub. Date: Aug. 28, 2008

(54) Abcycle or abdomicycle vehicle operated by upper body and steering system with leaning body

(76) Inventor: Shunsuke Akagi, Indianapolis, IN (US)

Correspondence Address: SHUNSUKE AKAGI, 5432 NORTH PARK DRIVE, INDIANAPOLIS, IN, 46220, US

(21) Appl. No.: 11/673,582

(22) Filed: Feb. 11, 2007

(51) Int. Cl. B62M 25/00; A63B 22/20; B62D 1/00; B65D 65/02; B62K 7/02; F16H 21/18

(52) U.S. Cl. 280/238; 482/68; 280/771; 74/47; 280/281.1; 150/154

(57) ABSTRACT

The Abdomicycle is a three or four-wheeled vehicle, (depending upon vehicle model) on which a rider sits upon a seat, leans back against a backrest which is provided for comfort and safety purposes and propels the vehicle either forward or reverse by a reciprocating motion on a bar that encloses them as they sit on the Abdomicycle. The bar is connected to either the single or dual rear wheels via a crank type mechanism that allows the linear pushing/pulling of the bar from front to back to be converted into a circular motion for the purpose of driving the rear wheel or wheels. The occupant's feet rest upon a forward steering linkage system that allows either foot pressure, or the leaning position of the occupant's body to turn the vehicle to the right or left. The vehicle includes a braking system connected by cable to the wheel(s) for the purpose of stopping the vehicle. The Abdomicycle is designed as a manually powered vehicle for exercises. However although it may defeat the purpose, motor or engine can be attached. Further more this system can apply to any vehicle such as ATV to stabilize turning.

### BACKGROUND OF THE INVENTION

People walk or ride bike to reduce fat on their belly. However bike, walking or other sports does not require abdominal muscle so much. Rowing a boat would be great for abdominal muscle exercise. However it has been difficult to achieve it on the land because when both hands are occupied, we do not steer so easily. Irish mail may be the closest vehicle but the motion of the Irish mail does not require so much abdominal muscle and it is very dangerous to steer when it goes fast. Sit up is very boring to do for 30 minutes. Therefore I cam up with this idea to maximize the exercise of abdominal muscle and to ride safely or to steer safely. Further more once we depart, we have to come back to home, so it obliges us to exercise for certain time with having fun. Once people reduce fat on their upper body, they can reduce the burden on their legs. Then people can exercise more, easily and safely. This invasion will be the new remedies for many people these days.

### A BRIEF DESCRIPTION OF THE DRAWINGS

FIG. 01: Abcycle with Parallelogram inclining steering system going straight.

FIG. 02: Abcycle with Parallelogram inclining steering system turning left.

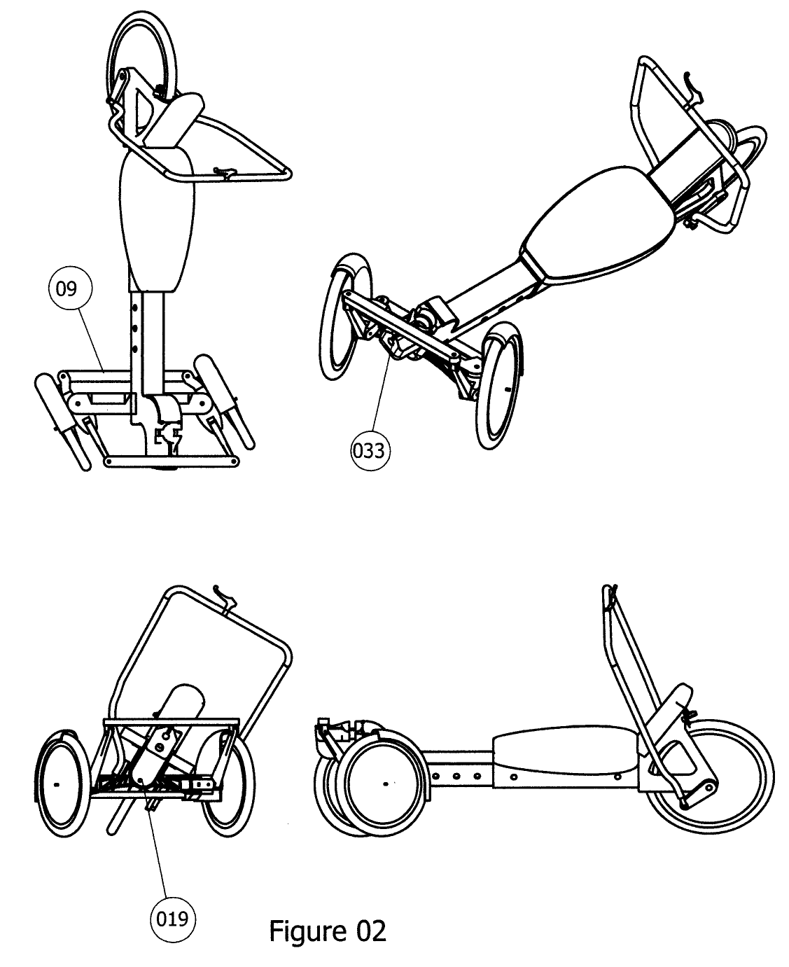

FIG. 03: Abcycle with Parallelogram inclining steering system turning right.

FIG. 04: Parallelogram inclining steering system detail and detached from Abcycle.

FIG. 05: Parallelogram inclining steering system detail turning left and detached from Abcycle.

FIG. 06: Parallelogram inclining steering system detail detached and folded.

FIG. 07: Parallelogram inclining steering system with front frame of Abcycle, wheels, cup holder and compartment.

FIG. 08: Parallelogram inclining steering system turning left with front frame of Abcycle, wheels, cup holder and compartment.

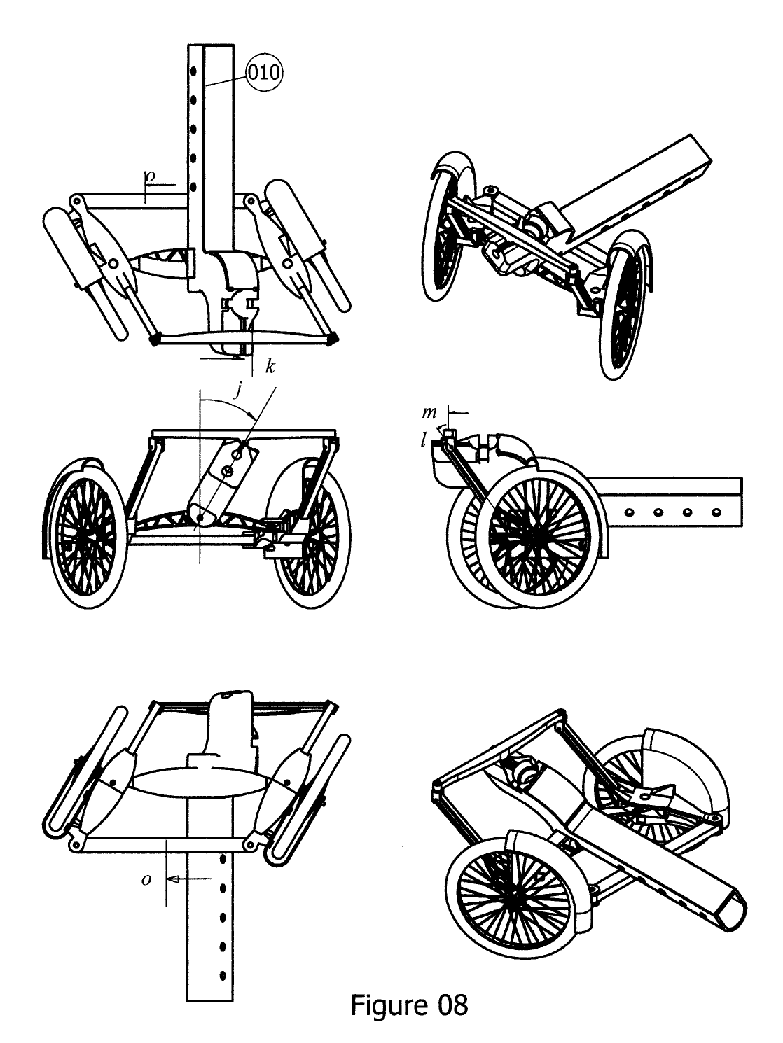

FIG. 09: Straight axle inclining steering system going straight with front frame.

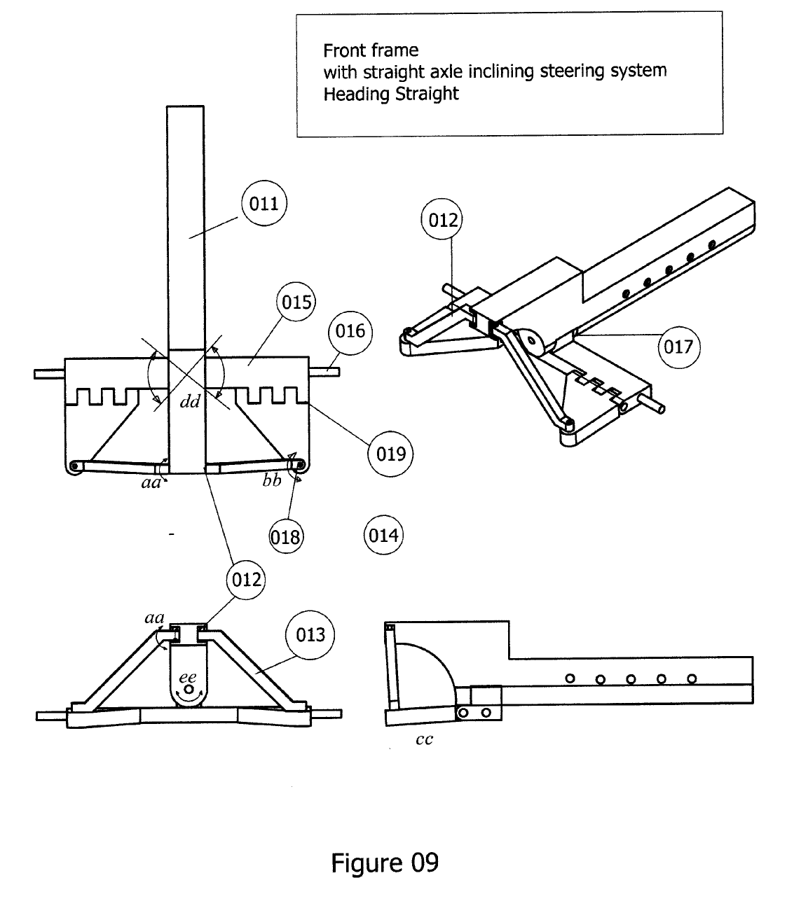

FIG. 010: Straight axle inclining steering system turning left with front frame.

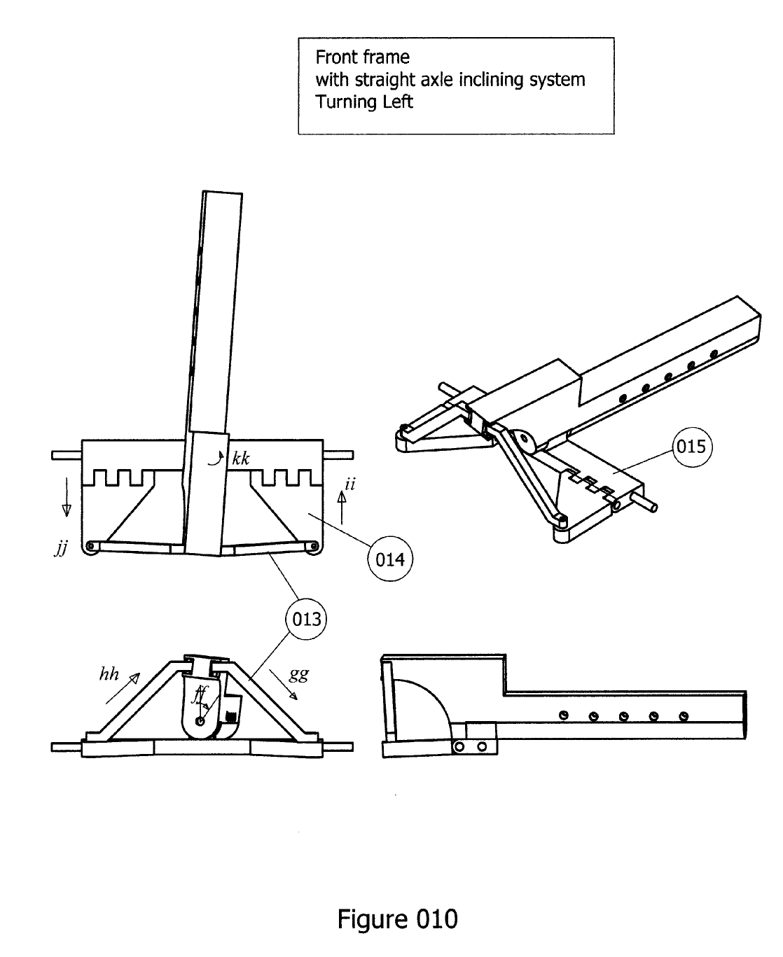

FIG. 011: Tree-wheel Abcycle rear drive part, crankshaft, handle and frame

FIG. 012: Four-wheel Abcycle.

FIG. 013: Variable crankshaft.

FIG. 014: Triangle inclining steering system going straight with front frame.

FIG. 015: Triangle inclining steering system turning left with front frame.

FIG. 016: Right and left universal wheel cover

FIG. 017: Frame joint

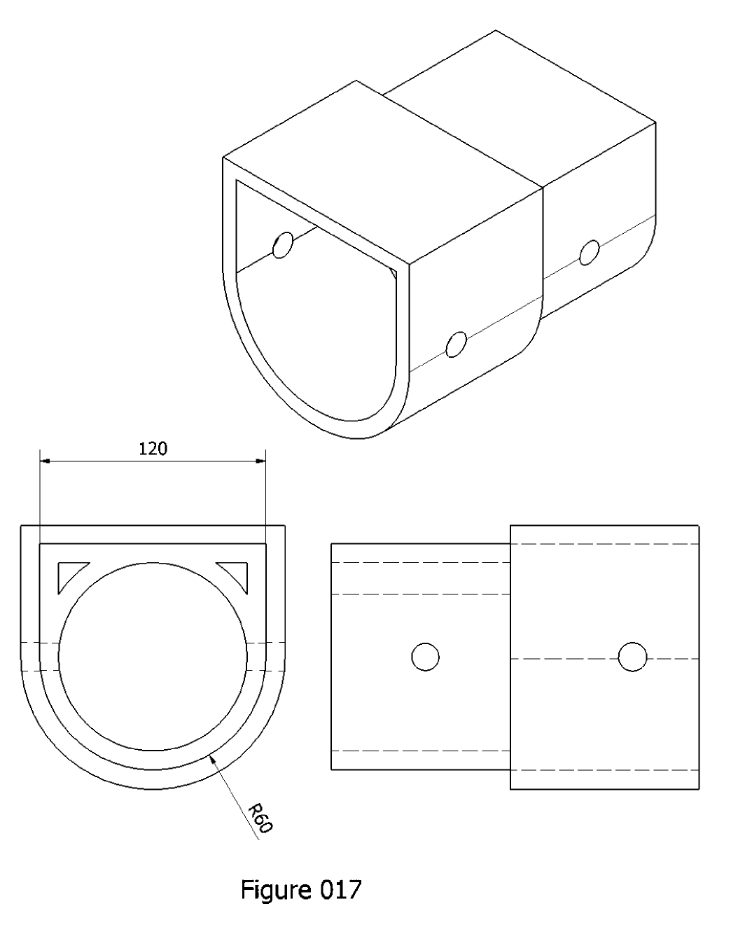

### DESCRIPTIONS

Vehicle operated by upper body and steering system with leaning body is defined as Abcycle or Abdomicycle as follows.

The Abcycle or Abdomicycle is composed of a series of connected assemblies that allow the vehicle to be operated as either a three or four-wheeled vehicle, (depending upon the model), powered in a forward or reverse motion by the occupant through the use of a pushing/pulling motion on a reciprocal bar to drive the rear wheel or wheels. The front wheels and steering mechanism are designed so that the occupant can turn to the right or left either by pressing on the foot bar or leaning the vehicle to the right or left.

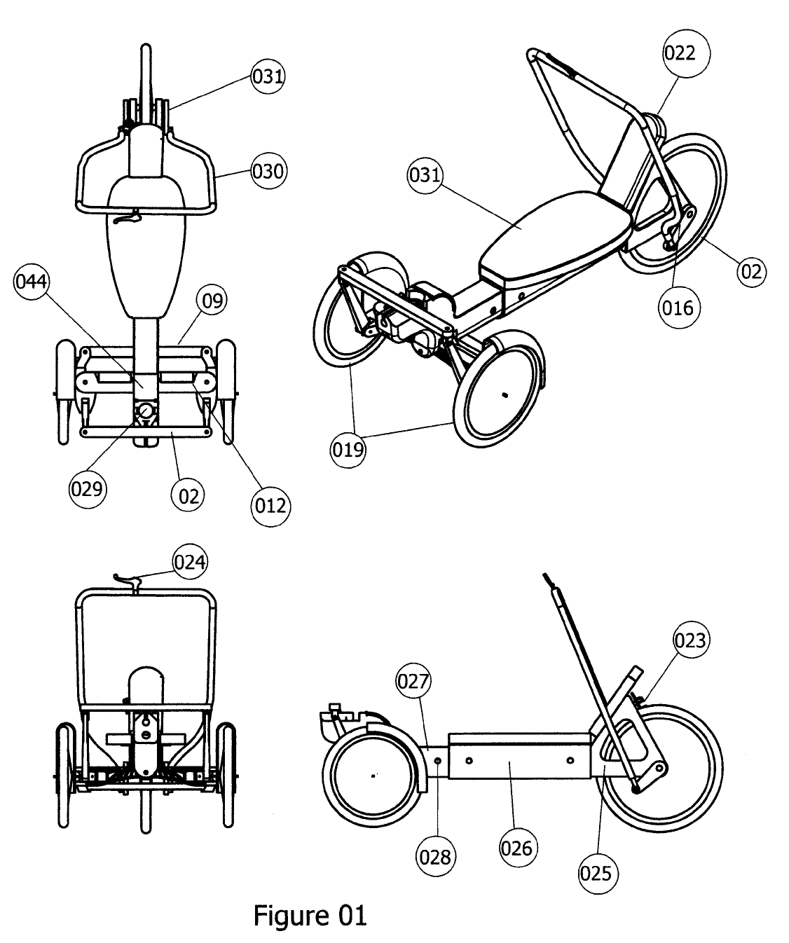

FIG. 01 shows four views of the three-wheeled Abdomicycle. Items 19 are the front wheels, similar to bicycle type pneumatic tires with a hub and either closed or open spokes, attached to turn freely. The tires may also be made of a variety of other materials. FIG. 01 also shows item-20 the rear wheel which is connected to the overall assembly by a hub and bearing system, it too is designed similarly to a bicycle tire with either open or closed spoke areas and has the ability to turn freely on its center set of bearings via a shaft. Although this system is described here, this is but for exemplary purposes only, so that the present invention should not be considered as limited exclusively thereto. Other means of achieving this result are contemplated within the spirit and scope of the invention

Item-21 shown in FIG. 01 is the seat portion of the Abdomicycle; it is an ergonomically contoured seat that allows the occupant to position himself or herself over the center of the Abdomicycle. Item-04 backrest is molded and contoured to be ergonomically correct and may or may not be padded, and allows the occupant to lean in a rear motion while riding the Abdomicycle.

Item-05, shown in FIG. 01, is caliper type braking system that allows pressure to be applied by item 06—in FIG. 01 which is a lever type braking system. There is a cable that connects lever 06 to brake caliper 05 for the purpose of applying pressure to the rim of rear wheel 02, for the purpose of slowing the vehicle via a braking action. Although this braking system is described here, this is but for exemplary purposes only, so that the present invention should not be considered as limited exclusively thereto. Other means of achieving this result are contemplated within the spirit and scope of the invention. A modified braking system is described later in the description.

Item-07, FIG. 01 shows the rear assembly of the Abdomicycle. The rear assembly 07 of the Abdomicycle is capable of being adjusted forward and backward by the virtue of its being square or rectangular in cross section and being capable of moving in a linear direction inside the larger seat tube 08. There is a series of alignment holes or detents that allow for rear assembly 07 to slide in and out of seat tube 08, made temporarily fastened in position according to the given dimensions and preference of the occupant. Seat tube 08 also contains in its opposite end the ability to accept front assembly frame 09. Although the rear assembly is described here, this is but for exemplary purposes only, so that the present invention should not be considered as limited exclusively thereto. Other means of achieving this result are contemplated within the spirit and scope of the invention.

Front assembly frame 09 can slide in and out of seat tube 8 and contains, through its center front assembly frame, pinhole for positioning. Front assembly frame pinhole 010, for positioning, allows for the adjustment in a linear direction for the extension or retraction of front assembly 09. It may then be held in position by the insertion of a pin or detent. At the forward portion of front assembly 09 is located foot steering bar and rest 011. Although the front assembly is described here, this is but for exemplary purposes only, so that the present invention should not be considered as limited exclusively thereto. Other means of achieving this result are contemplated within the spirit and scope of the invention.

Abdomicycle steering system

There are four different steering systems for Abdomicycle. The first one is Parallelogram inclining steering that appears to be parallelogram and the second is triangle inkling steering system that appears to be triangle system from front view. The third one is leaning system with straight axle. These are leaning turn system. The third system is used for four wheels model. No inclining system with knuckles and heel steering. These inclining system can be used for four wheels but it is not necessary. Italic alphabets show each movement or direction in figures from 04 to 010, 014 and 015.

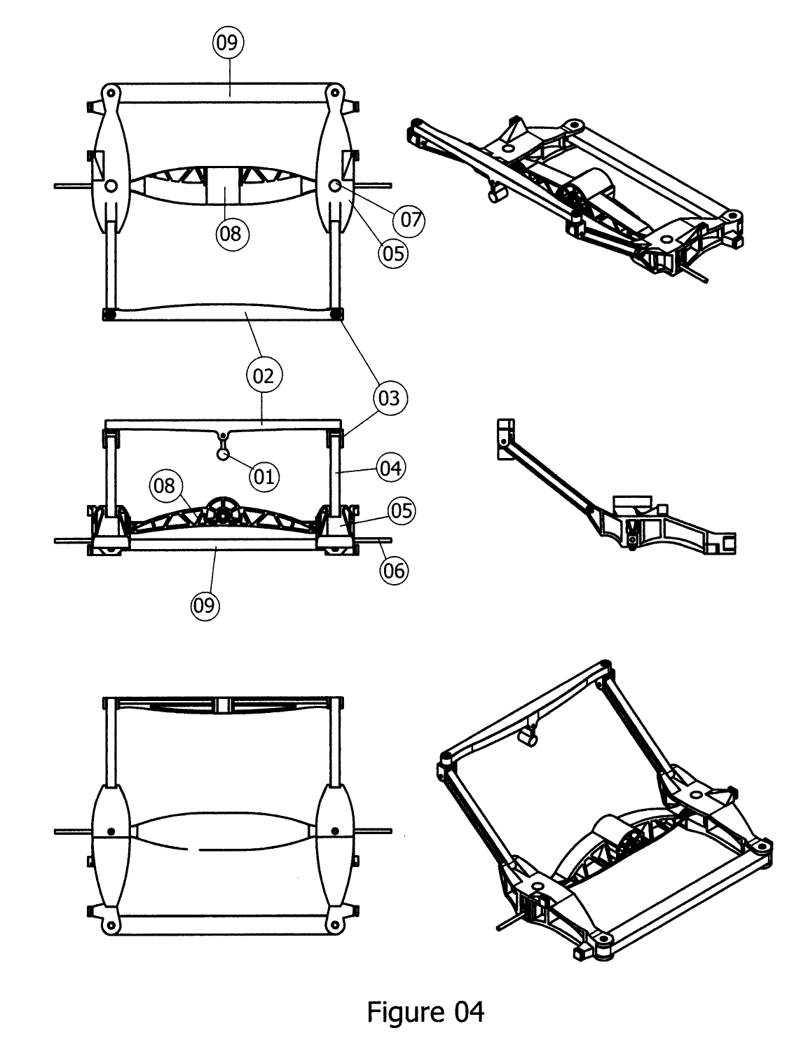

See FIG. 04. Parallelogram inclining steering system consists of slider 01, top cross bar 02, a pair of two way joints 03 or ball joints, a pair of diagonal bars 04, a pair of knuckles 05, a pair of shafts 06, knuckle pins 07, main cross bar 08, heel steering bar 09. Slider 01 can be eliminated by using straight rod instead of groove on front frame and top cross bar with hole in the center, which the straight rod goes thorough. However this structure would make removable function more difficult but it is easy to achieved.

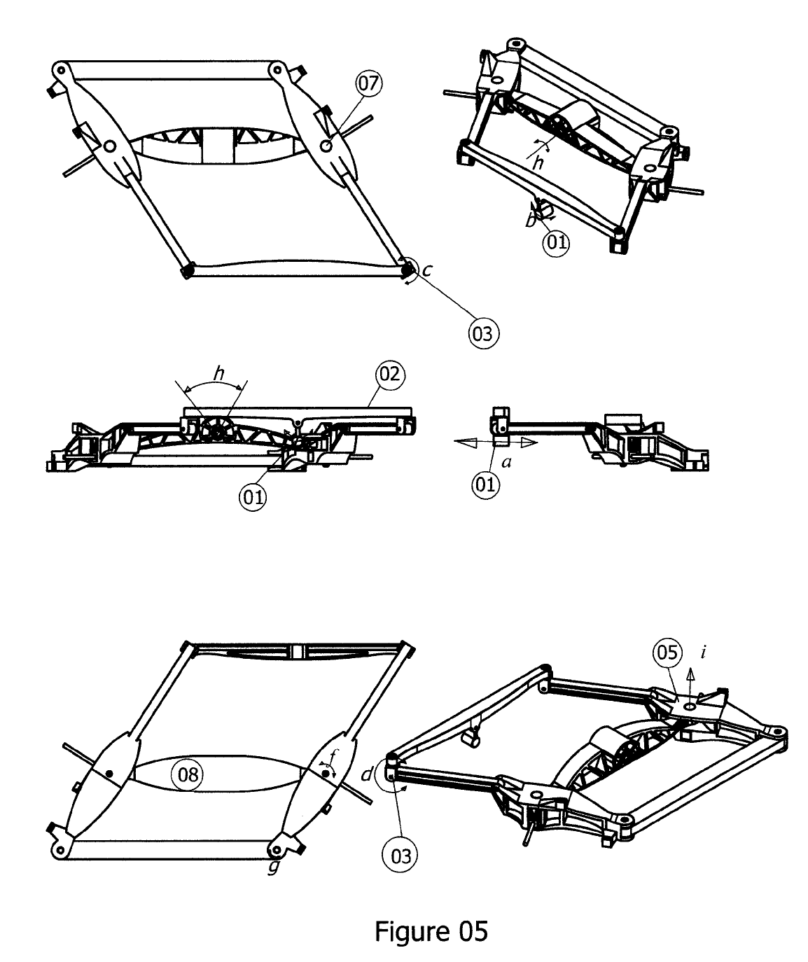

See FIG. 05. Movement is that slider 01 move back and forth a in the groove on front frame, pivot b at center and bottom of top cross bar 02, joints 03 rotate c horizontally at ends of top cross bar 03 and rotate da t end of diagonal bars. Joints 03 can be replaced with ball joint. The other end of diagonal bar connects to knuckle and rotates e. Knuckle 05 connects to main cross bar 08 and rotates f. The back end of knuckle and heel bar connects and rotates g. Hole in the middle of main cross bar 08 connects to front frame and rotates h. These are the movements for steering purposes. Pin 07 connects joint knuckle 05, main cross bar 08 and shaft 06. Pin 07 can be removed i to disconnect items 05, 06 and 08.

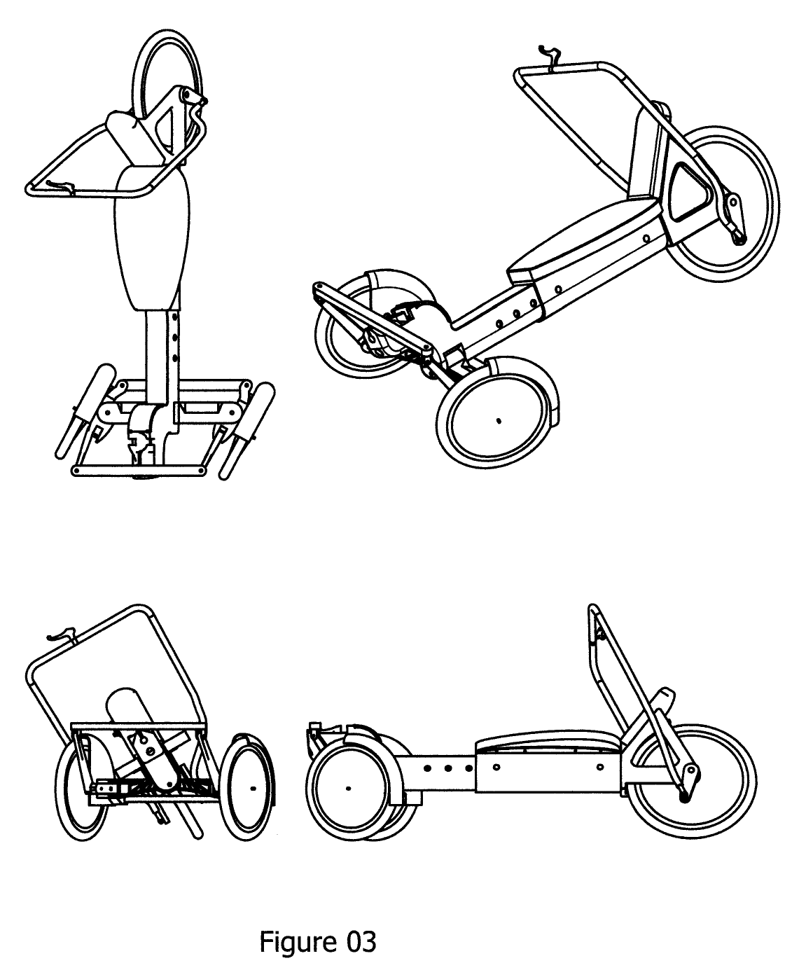

See FIG. 03. This drawing shows that when the pin on main cross bar is disconnected from the front frame, it can be folded like this. To achieve this function, front end of knuckle needs to be raised or the diagonal bar needs to be bent. This drawing shows the former method. The offset of the raised end would be dependent on the width of diagonal bar.

See FIGS. 04 and 05.

This drawing shows Parallelogram inclining steering with front frame.

Explanation of turning left.

When I lean to my left, front frame will lean to left j. Slider 01 pushes k top cross bar 02 to left. Movement b will keep top cross bar horizontal. Top cross bar 02 pushes k left diagonal bar 04 and pulls k right diagonal bar 04. Front frame 010 inclines j so that diagonal bars go down. Since they 04 go down /, they 04 push forward m top cross bar 02. Slider 01 compensates the forward movement m of top cross bar with movement a. Since diagonal bars 04 turn to left n, knuckles 05 rotate f and n to left and wheels connected to shafts 06 turn to left.

Heel bar 09 overrides turning from shifting side to side by heels. Toes are on main cross bar 08.

When turning left if I lean right, vehicle would fall, but this system overrides inclining inward, in this case, leaning to left.

Although this steering system is described here, this is but for exemplary purposes only, so that the present invention should not be considered as limited exclusively thereto. Other means of achieving this result are contemplated within the spirit and scope of the invention.

Explanation of Triangle inclining steering system:

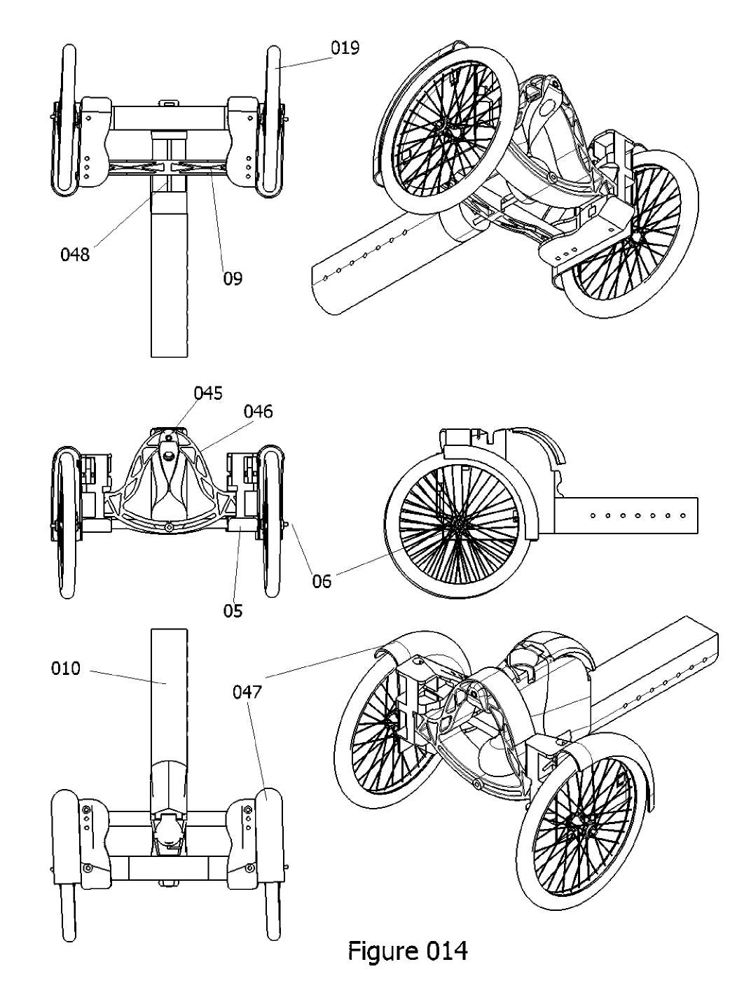

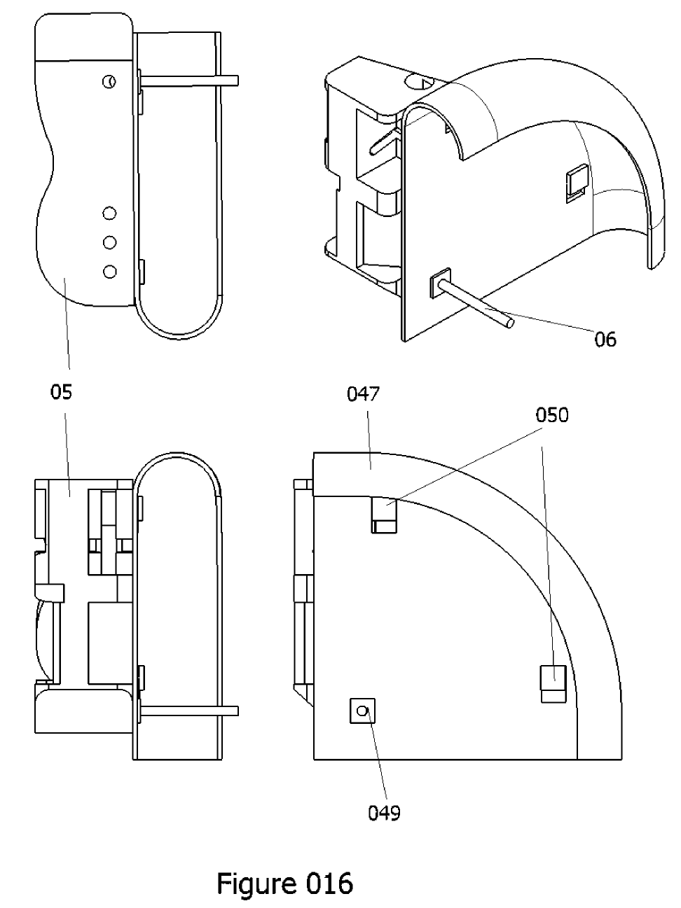

See FIG. 014. Front Frame 010 has a joint at front upper end 045. This joint connects to the triangle or arch shaped arm 046. This arm 046 connects to the front of Right and left knuckles 05. This knuckle 05 holds a universal tire cover with two hooks in holes 050 and wheel shaft 06. See FIG. 016. Tire cover slide into hooks 050 on knuckle 05 and lock with a shaft 06 in hole 049. Heel bar 09 joints with right and left knuckle 05 at back of knuckles. This heel bar 09 has an elongated hole and shaft 048 goes through. This shaft 048 also may or may not go through triangle arm 046. This shaft is located at bottom of body and behind the triangle arm. This system is much simple and also gives stability because the center of the gravity is located below the pivot point.

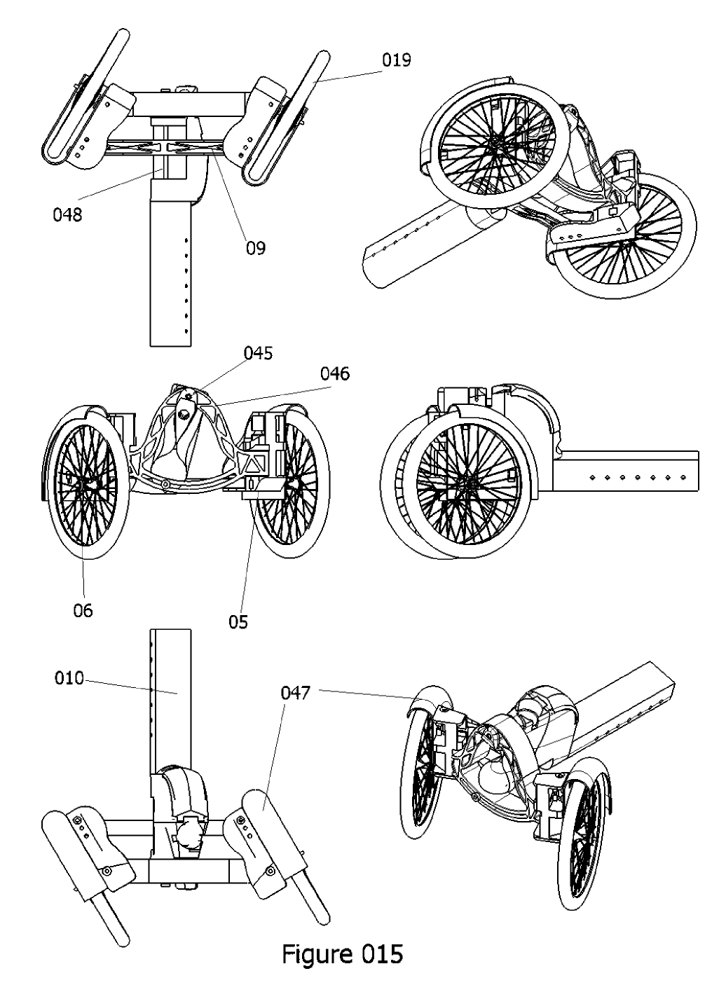

See FIG. 015. This drawing shows that when you turn left. When you lean body 10 to left, rod 048 pushes heel bar 09 to right since the bottom of body 010 goes to right. Heel bar 09 pushes right knuckle 05 and pulls left knuckle 05 to right. Therefore the tires turn left. Turning is possible with placing feet and moving Knuckles 05 or heel bar 09,

Explanation of Straight axle inclining steering system:

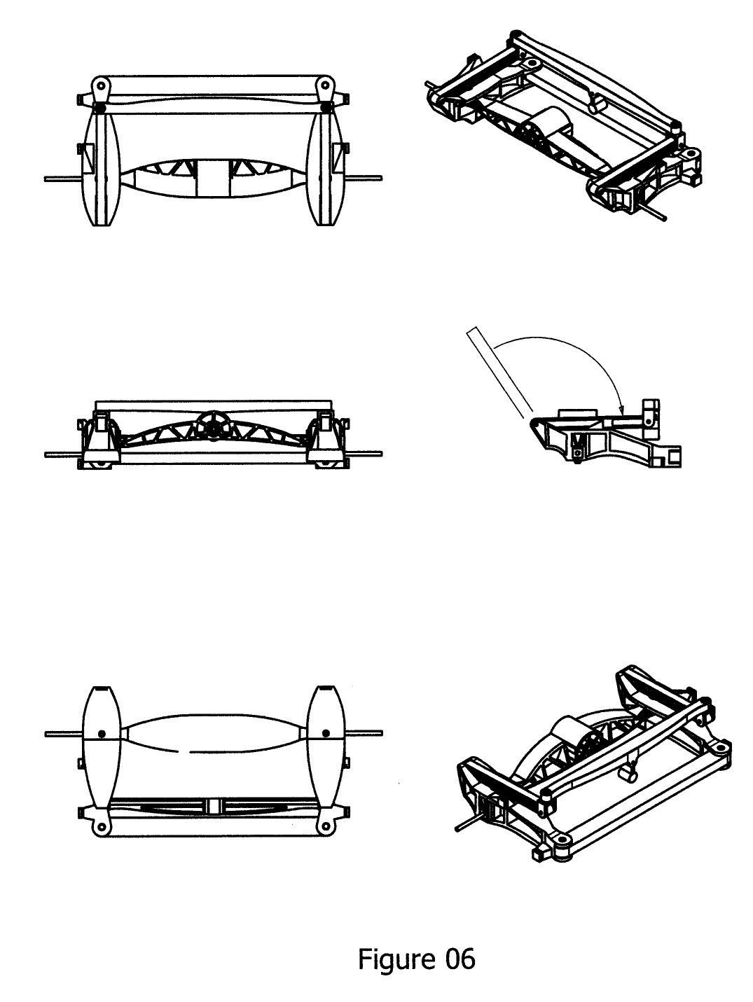

See FIG. 06. This Straight axle means that it does not have joints such as knuckles on wheel axle and both right and left wheels are connected straight without any joints. Front frame 011 for straight axle system has a pair of joints 012 at front end. These joints can be I-bolt or a lose type joint. Diagonal bars 013 are connected on these joints 012. The other end connects on the front end of boards or rods 014. The other end connects to main shaft. This main shaft 015 has shafts 016 for wheels. It 015 connects to front frame 011 with two way joints.

Explanation of parts movement:

Joint 012 lets diagonal bar move all directions aa along with loose joint. Joint 018 is also a loose joint bb.

Joint 019 pivots cc on axis. Joint 017 moves two ways, horizontal dd and rotary ee.

Explanation of straight axle steering system turning left:

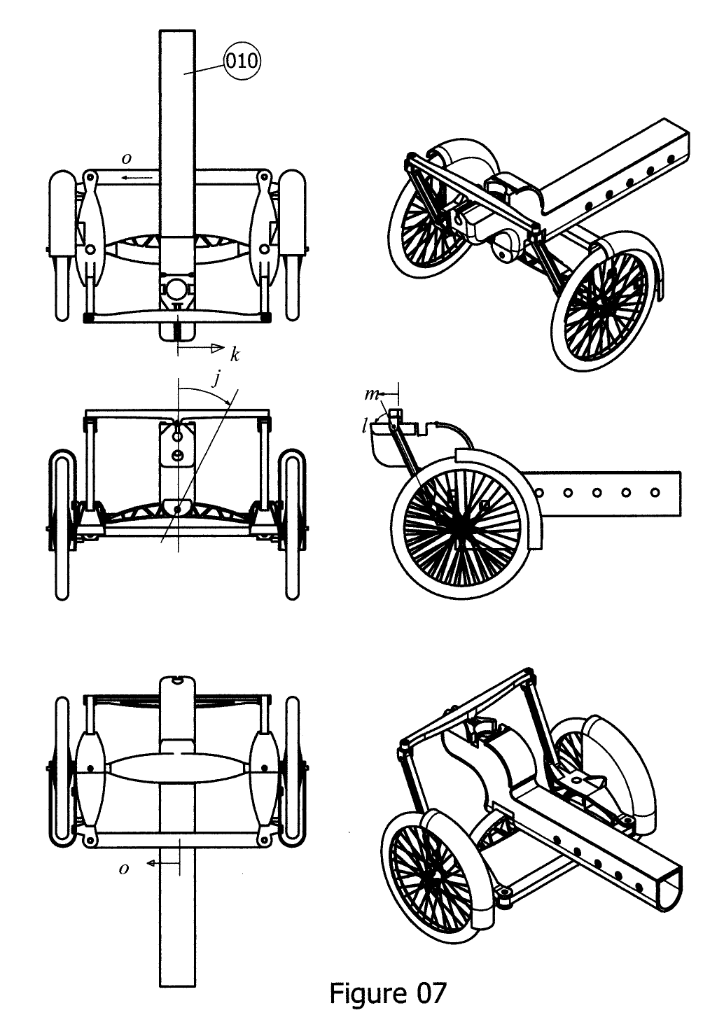

See FIG. 07.

When I lean to left, front frame 011 leans to left ff. Left Diagonal bar 013 pushes gg left rod 014. Right diagonal bar 013 pulls hh right rod 014. Left rod 014 pushes back ii main shaft 015. Right rod 014 pulls jj main shaft 015. Joint 017 allows front frame 011 lean left ff and rotate kk main shaft 015.

I can override turning with feet not heels by pushing right side of main shaft 015. Left diagonal bar 013 pulls front frame 011 and right diagonal bar 013 pushes frame 011 and forces front frame to lean inward, in this case, leaning to left stabilizing turning.

Although this steering system is described here, this is but for exemplary purposes only, so that the present invention should not be considered as limited exclusively thereto. Other means of achieving this result are contemplated within the spirit and scope of the invention.

The forward portion of front frame 010 contains a depression 029, which serves to hold a drink or water bottle for occupant's use. Item 44 is cover for storage box underneath.

The actual forward or reverse movement of the Abdomicycle is achieved by the occupant sitting in the seat 021, and placing right and left toes on the corresponding main cross bar 08 and right and left heels on the corresponding heel bar 09, then lowering bar 030 from a vertical position across and in front of their body, and then grasping bar 030 with their right and left hands at approximately abdomen level in front of them. By pressing forward and forming a reciprocal circle with the bar, the motion is transferred to the back to crank 031. Crank 031 is attached by a pivoting joint on each side to bar 030. There is a crank 031 located on each side of the three-wheeled vehicle and there is a corresponding yoke attached on the four-wheeled vehicle, which I will describe later. The crank's s distance between centers of the pivot point on the bar and its permanent fixturing to the shaft, allow it to connect to rear wheel 020. This reciprocating movement of the bar allows it to be converted to a rotary motion at the rear of the vehicle via the movements of the crank thereby moving the entire vehicle to the forward or the rear. Although this system is described here, this is but for exemplary purposes only, so that the present invention should not be considered as limited exclusively thereto. Other means of achieving this result are contemplated within the spirit and scope of the invention.

The Abdomicycle is primarily designed to be driven in a forward motion but can be used to go in reverse if necessary; during this action the occupant's right or left hand is placed over or near the brake lever 024, allowing for a stopping action to be applied should there be a need. The front and rear wheels of this vehicle will most likely be shielded with some type of fender that will minimize a slinging action from any items or water picked up on the road and therefore keep the occupant clean and comfortable.

FIG. 03 shows the same aspect but with the vehicle performing a right turn in relationship to the position the occupant would be in.

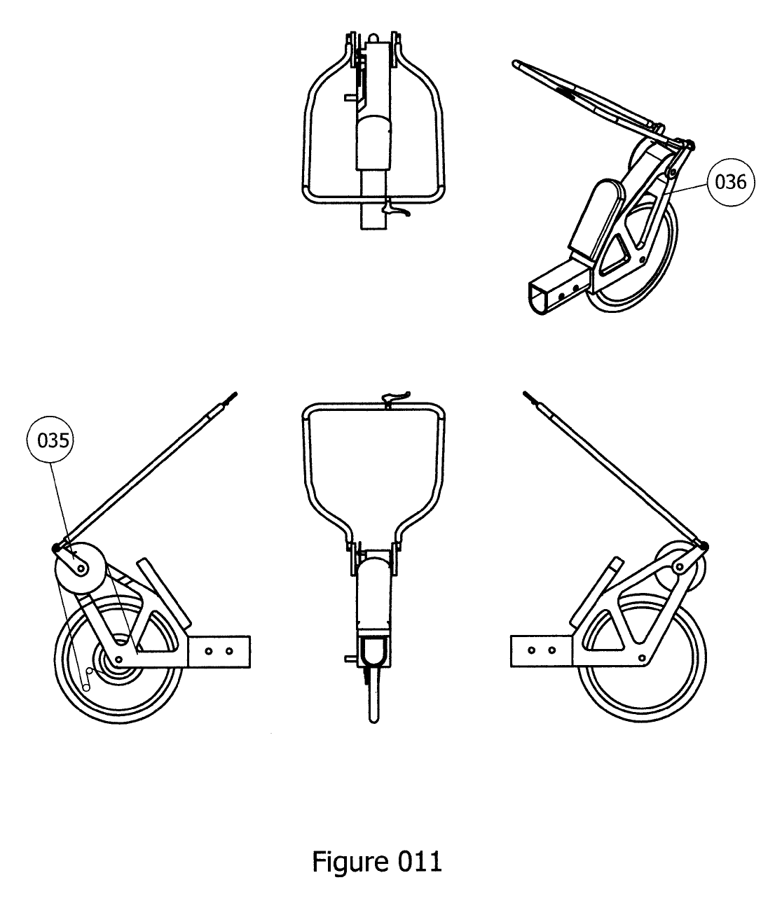

FIG. 11 shows item 035 which is the de-railer system and chain and FIG. 036 which is the rear axle that allows the system commonly used on a multi-speed bicycle to be applied to the bar 030 and modifying the rear assembly 036 so that a series of multiple speeds and rams can be achieved, for the purpose of gaining mechanical advantage, by merely modifying the rear frame and the mounting portion of bar 030.

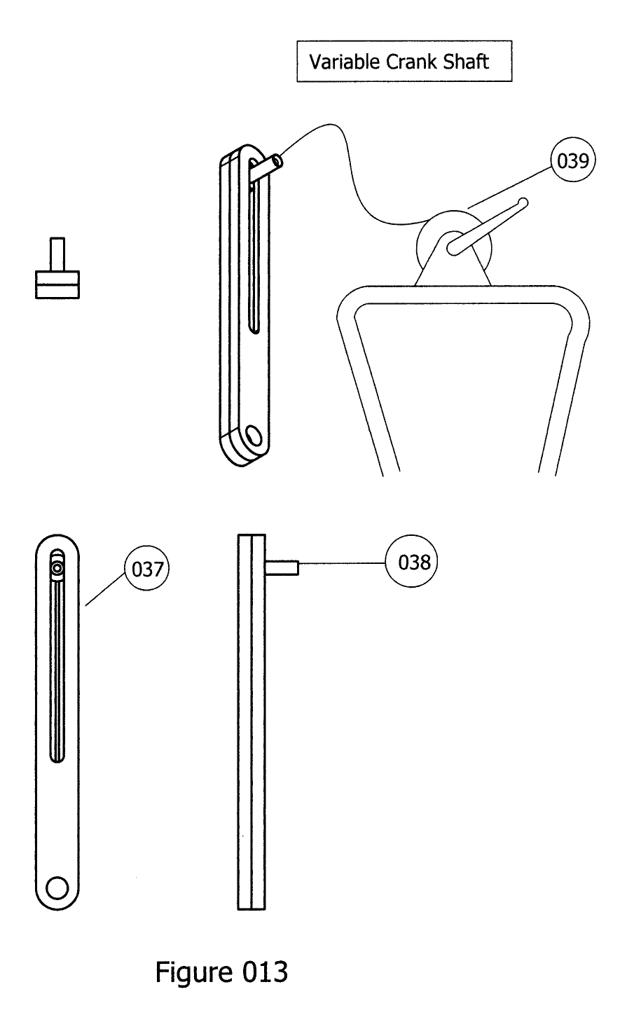

FIG. 013 shows item 037, which is the possible use of a variable length crank. FIG. 037 has pin 038 located in such a fashion that it can be moved in a linear direction along the crank for the purpose of increasing or decreasing the length of the throw. The increase or decrease in the length of the throw would be accomplished by item 039 which is the bar mounted control for the variable crank that would allow the operator to select the length of the crank itself and thereby the mechanical advantage applied by selecting it through a tabling system that would mechanically change the distance between the center pin throw and the pin itself.

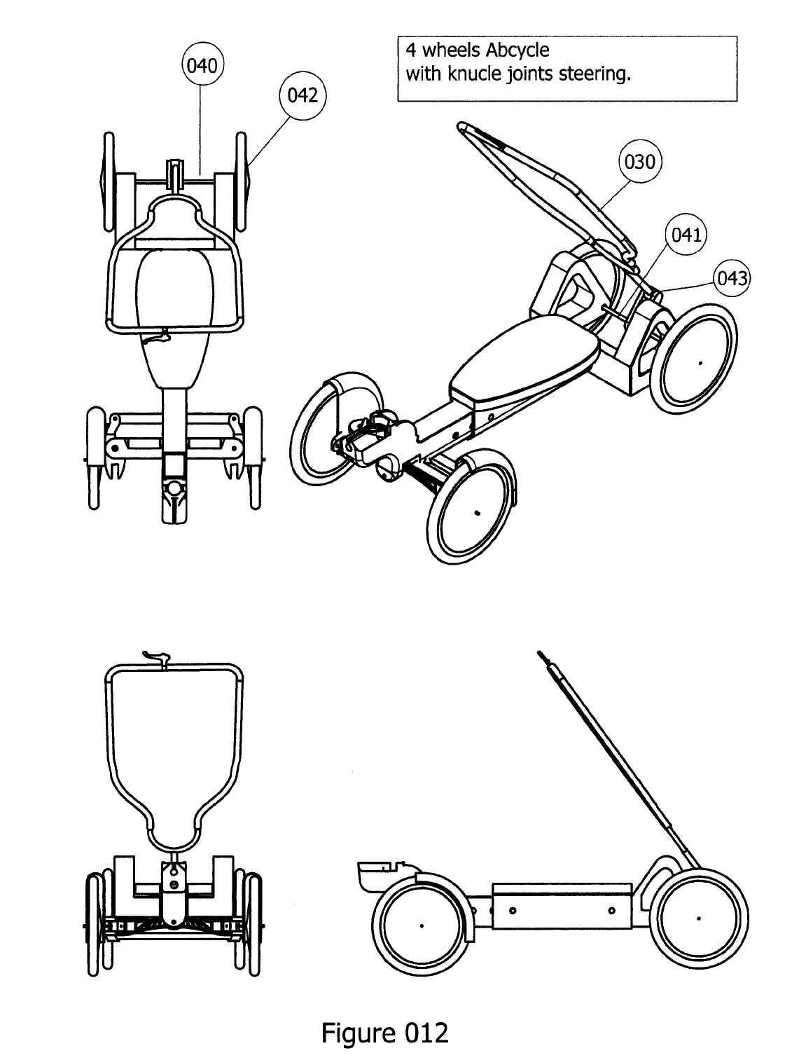

FIG. 012 shows the views of an Abdomicycle containing two front wheels and two rear wheels. The addition to this would be a modification of the rear frame and the addition of items 040 a four wheel rear axle, and 041 a disc breaking system, for the purpose of stopping the motion of the rear axle. FIG. 012 also shows the possibility for having item 042 an internal brake, on the axle end of the wheel, and also shows item 043, the crank on the four wheel Abdomicycle, that allows the motion from bar 030 to transmit the energy required to the drive axles on the rear of the four wheel Abdomicycle using the center crank. Although this system is described here, this is but for exemplary purposes only, so that the present invention should not be considered as limited exclusively thereto. Other means of achieving this result are contemplated within the spirit and scope of the invention.

The Abdomicycle described therein has focused on the use of the three or four-wheel model as an exercise tool and transportation vehicle. The use of this concept as a stationary indoor exercise machine is an extremely viable option of this design. The adaptation of the framework and the use of the resistance mechanisms to simulate the operation of the previously described Abdomicycle would be very straightforward and would allow the owner the capability to train with or for the use of the Abdomicycle in an indoor setting. This vehicle could be designed as a stationary piece of exercise only, as an exercise/transportation vehicle, or the Abdomicycle itself could be designed so that its components allowed the owner the capability of using the same Abdomicycle with modular components for either indoor or outdoor use. Though this system is described here, this is but for exemplary purposes only, so that the present invention should not be considered as limited exclusively thereto. Other means of achieving this result are contemplated within the spirit and scope of the invention.

### PARTS LIST

01. Slider
02. Top cross bar
03. Two way joint
04. Diagonal bar for parallelogram system
05. Knuckle
06. Front wheel shaft
07. Knuckle pin
08. Main cross bar
09. Heel bar
10. Front Frame
11. Front Frame for Straight axle system
12. Joint
13. Diagonal bar for Triangle system
14. Steering plate or rod
15. Main shaft
16. Front wheel shaft
17. Two way joint for Front frame and Main shaft
18. Joint for diagonal bar and steering plate
19. Front wheel
20. Rear wheel
21. Seat
22. Back rest
23. Brake caliper
24. Brake lever
25. Rear assembly
26. Seat tube
27. Front assembly frame
28. Front assembly pinhole for positioning
29. Drink holder recess
30. Handle Bar or Driving bar
31. Crank
32. Hinge area
33. Slider groove
34. Front frame lower pivot area
35. De-railer system and chain
36. Modified rear assembly
37. Variable crank
38. Variable crank adjustment pin
39. Bar mounted control for variable crank
40. Four wheel rear axle
41. Disc brake
42. Internal brake
43. Center crank for bar
44. Cover for Storage box
45. Swing Hinge
46. Triangle arm
47. Tire cover
48. Rod at bottom of front frame
49. Hole for axle
50. Holes for hooks

What is claimed is:

1. Abdomicycle;
a. A tricycle or four-wheel vehicle driven by upper body and arms or motor;
b. I define this vehicle as Abdomicycle or Abcycle because this vehicle is originally invented to reduce fat on the belly by moving upper body constantly; A whole A tricycle or four-wheel vehicle driven by upper body and arm with said leaning steering system and drive system, driving system may be substituted with motorized power, indoor model does not require steering system and exercise machine for upper body and arms;
c. Said Abdomicycle is a whole vehicle which is comprising two wheels at front with said leaning steering system and one or two wheel(s) drive system at rear, let us drive with upper body, hands and arms, steer with leaning body or shift with foot. The leaning steering system also let the operator stabilized.

2. Parallelogram inclining steering system as in claim 1:
a. A steering system for said Abdomicycle;
b. A steering system that is comprising said slider which is connected and slides on said front assembly frame or a main body and which also pivotally mounted to said top cross bar at the middle of said top cross bar, a pair of said diagonal bars pivotally mounted to said top cross bar, a pair of said knuckles, which hold wheels, pivotally connected to these diagonal bars, said main cross bar pivotally mounted to these knuckles, said front assembly or a main body pivotally mounted to this main cross bar at its middle, heel bars pivotally connected to both said knuckles;
c. Said slider may be substituted with a rod and a hole at the middle of said top cross bar;
d. When an operator lean to his/her right or left, said main body, which pivotally connected to said main cross bar, leans, said slider pushes said top cross bar, said cross bar pushes/pulls said diagonal bars, these diagonal bars twist knuckles so that two wheels on these knuckles turn, since diagonal bars and knuckles rotate, said slider slides backward.

3. Triangle inclining steering system as in claim 1:
a. A steering system for said Abdomicycle;
b. A steering system that is comprising said triangle arm pivotally mounted to said front assembly or a main body, a couple of knuckles holding wheels pivotally connected to said triangle arm, heel bar pivotally connected to knuckles, heels bar has an elongated hole where said rod at bottom of front frame is through and this rod is connected to said front frame or a main body.
c. The rods at top and bottom of the frame can be removed or slid to disengage this system from the body;
d. When an operator lean to his/her right or left, the main body swing to his/her left or right with pivoting at top of said triangle arm, the rod on said front frame or main body pushes said heel bar so that the knuckles are pushed/pulled and turn, wheels on these knuckles turn.

4. Straight axle inclining steering system as in claim 1:
a. A steering system for said Abdomicycle;
b. A steering system that is comprising a couple of said diagonal bars pivotally connected to the top of said front frame or a main body, said steering plates or rods pivotally connected to these diagonal bars, said main cross bar holding wheels at its both ends pivotally connected to these steering plates or rods, this main cross bar pivotally connected to said main frame or a main body;
c. When an operator leans, the main body pivots at bottom of said front frame, diagonal bars pushes/pulls steering plates or rods, steering plates or rods pushes/pulls said main cross bar so that this main cross bar rotate and wheels turn.

5. Feet steering system as in claim 1:
a. A steering system for said Abdomicycle;
b. A steering system that is comprising said main cross bar connected to said front frame or a main body, a couple of said knuckles holding wheels pivotally connected to this main cross bar, heel bar pivotally connected to these both knuckles.
c. When operator shifts said heel bar with heels or feet or turns said knuckles, wheels turn.

6. Four wheels or three wheels hand or upper body reciprocating motion crankshaft drive system as in claim 1:
a. A drive system for said Abdomicycle;
b. A drive system that comprises said wheel(s), said crankshafts connected to the axle of the wheel(s), said handle bar pivotally connected to these crankshafts.
c. When an operator moves said handle bar by his/her hand or upper body with reciprocating motion, crankshafts rotate the axle of said wheel(s).

7. Gear change system availability as in claim 1:
a. Gear change system is available on drive system for said Abdomicycle.
b. Gear system can change the gears rotation.

8. Variable crankshaft system as in claim 1:
a. A variable crankshaft system for said Abdomicycle;
b. A variable crankshaft system can change the length of crankshaft with wire from an operator's switch.

9. Adjustable and detachable frames as in claim 1:
a. Frames are adjustable and detachable for said Abdomicycle;
b. Frames are detachable for storage or carrying, adjustable for the different size of people.

10. Frame equipped with light hole, cup holder or storage area as in claim 1:
a. A frame with a cup holder(s) and a storage space(s) for said Abdomicycle
b. A frame comprises a cup holder(s) and storage space(s).

11. Detachable and foldable steering system as in claim 1:
a. A detachable and foldable steering system for said Abdomicycle;
b. Said steering system is detachable and foldable.

12. Indoor or outdoor exercise equipments with reciprocating motion by hand or upper body as in claim 1:
a. An indoor exercise equipments for said Abdomicycle;
b. A stand(s) and load roller allow us indoor exercise.

13. Right and left common tire cover and method of attachment as in claim 1:
a. A tire cover for said Abdomicycle;
b. A tire cover comprises a hole for a shaft of a wheel, and two holes located properly so that said tire cover fits both right side and left side of said knuckles.
